(19) United States
(12) Patent Application Publication
(10) Pub. No.: US 2015/0286627 A1
(43) Pub. Date: Oct. 8, 2015

(54) CONTEXTUAL SENTIMENT TEXT ANALYSIS

(71) Applicant: Adobe Systems Incorporated, San Jose, CA (US)

(72) Inventors: Walter W. Chang, San Jose, CA (US); Emre Demiralp, San Francisco, CA (US); Shantanu Kumar, Delhi (IN); Shanshan Xia, Beijing (CN)

(73) Assignee: Adobe Systems Incorporated, San Jose, CA (US)

(21) Appl. No.: 14/244,665

(22) Filed: Apr. 3, 2014

(51) Int. Cl. G06F 17/27; G06F 17/28

(52) U.S. Cl. CPC G06F 17/2705; G06F 17/28

(57) ABSTRACT

In techniques for contextual sentiment text analysis, a sentiment analysis application is implemented to receive sentences as text data, and each of the sentences can include one or more sentiments about a subject of the sentence. The text data can be received as part-of-speech information that includes noun expressions, verb expressions, and tagged parts-of-speech of the sentences. The sentiment analysis application is implemented to analyze the text data to identify the sentiment about the subject of a sentence, and determine a context of the sentiment as the sentiment pertains to a topic category of the subject in the sentence, where the topic category of the subject is determined based on text categorization of the text data. The sentiment analysis application can also determine whether the sentiment is positive about the subject or negative about the subject based on the context of the sentiment within the topic category of the subject.

### BACKGROUND

Marketing analysts strive to obtain information about topics that customers are discussing and communicating, as well as the opinions or sentiments that may be expressed by the customers in communications about the topics. Companies that provide products and/or services want to know and understand how well a product or service is received, areas where customers are unhappy with the product or service, and to identify product and/or service suggestions or enhancements from customers. The volume of information to analyze is often quite large, such as thousands of comments per week. To manually sort out the positive, negative, and actionable suggestion comments from customers is labor intensive, tedious, and can be error-prone.

Conventional approaches to determine the topics that are being discussed and the related sentiments are typically based on statistical keyword models that are subject to numerous false positives and negatives due to sensitivity of the models to the domain or context of the topics. For example, an existing model may include a controlled vocabulary of positive and negative sentiment words, such as “good”, “excellent”, “bad”, and “awful”, which are invariant and not likely to be misinterpreted.

However, sentiment and emotion terms are highly contextual, such as the word “predictable”, which may connote something good about an accurate measuring device or a reliable digital stylus, but can reflect something bad about a movie review that indicates the movie was “predictable”. Additionally, existing models generally only count keywords, yet fail to take into account adjective negation, such as in the examples “the movie was not very good”, or “the food was really not bad at all.” A negative word may be used several words separated from the adjective in a sentence. The existing models may mistakenly determine that “the movie was good” without accounting for the adjective negation, “not very”, and mistakenly determine that “the food was bad” without accounting for the adjective negation, “really not”. Accordingly, the interpretation of many sentiment and emotion terms is highly contextual-based.

### SUMMARY

This Summary introduces features and concepts of contextual sentiment text analysis, which is further described below in the Detailed Description and/or shown in the Figures. This Summary should not be considered to describe essential features of the claimed subject matter, nor used to determine or limit the scope of the claimed subject matter.

Contextual sentiment text analysis is described. In embodiments, a sentiment analysis application is implemented to receive sentences as text data, and each of the sentences can include one or more sentiments about a subject of the sentence. The text data can be received as part-of-speech information that includes noun expressions, verb expressions, and tagged part-of-speech of the sentences. The sentiment analysis application is implemented to analyze the text data to identify the sentiment about the subject of a sentence, and determine a context of the sentiment as the sentiment pertains to a topic category of the subject in the sentence, where the topic category of the subject is determined based on text categorization of the text data. The sentiment analysis application is also implemented to determine whether the sentiment is positive about the subject or negative about the subject based on the context of the sentiment within the topic category of the subject.

In embodiments, the sentiment analysis application is implemented to identify the noun expressions, the verb expressions, and adjective expressions that are meaningful to the sentiment about the subject of a sentence. Adjective forms of the adjective expressions can be determined utilizing a dictionary database of categorized sentiment vocabulary words to identify sentence phrases that are meaningful to the sentiment about the subject. One or more topics of the sentence can be identified based on the noun expressions, and each of the topics are associated with the sentiment about the subject of the sentence. The sentiment analysis application is also implemented to aggregate the sentiment about the subject for each of the topics of the sentence to score each of the noun expressions as represented by one of the topics of the sentence. The sentiment analysis application then determines positive sentiments about the subject, negative sentiments about the subject, recommendations about the subject, and suggestions about the subject based on the scoring of the topics of the sentence. A weighted average of sentence sentiment scores can then be computed to determine an overall sentiment about the subject of the sentence, or for multiple sentences.

### BRIEF DESCRIPTION OF THE DRAWINGS

Embodiments of contextual sentiment text analysis are described with reference to the following Figures. The same numbers may be used throughout to reference like features and components that are shown in the Figures:

FIG. 1 illustrates an example of a device that implements a sentiment analysis application to implement contextual sentiment text analysis in accordance with one or more embodiments.

FIG. 2 illustrates example method(s) of contextual sentiment text analysis in accordance with one or more embodiments.

FIG. 3 illustrates an example implementation of the sentiment analysis application in accordance with one or more embodiments of contextual sentiment text analysis.

FIG. 4 illustrates example method(s) of contextual sentiment text analysis in accordance with one or more embodiments.

FIG. 5 illustrates an example system in which embodiments of contextual sentiment text analysis can be implemented.

FIG. 6 illustrates an example system with an example device that can implement embodiments of contextual sentiment text analysis.

### DETAILED DESCRIPTION

Embodiments of contextual sentiment text analysis are described as techniques to analyze text data, such as in the form of textual documents, social messages, blogs, reviews, and interactive dialogs and communications, and to determine both moment-to-moment and aggregate sentiments expressed in the communications at individual topic and sentence levels, as well as across the entire communications. A sentiment analysis application is implemented to detect and analyze sentiments, which is inclusive of sentiments, emotions, opinions, suggestions, and recommendations. The techniques also provide analysis outputs and reports that indicate context of the sentiments as they pertain to topic categories, and as positive sentiments, negative sentiments, suggestions, and/or recommendations determined from the source text data.

Clients, such as marketers and product and/or service providers, can utilize the analysis outputs and reports to determine topics that customers are discussing or communicating, as well as the related sentiments, emotions, and opinions that are being expressed by the customers in their communications. The sentiment analysis application is implemented to classify customer feedback text in positive or negative sentiment categories that are scored, determine a scored level of emotion or affect that is present in a customer comment, and determine customer comments that are suggestions or recommendations for changing or enhancing a product and/or service.

The techniques for contextual sentiment text analysis described herein implement a hybrid use of statistical and natural language methods to analyze the text data, such as in the form of messages and documents, that may contain complex sentence structure and negation in the textual expression of sentiment and emotion. Further, the contextual sentiment text analysis provides for extensible modular ontologies that allow the system to learn topics for specific domains, and provides for the use of extensible contextualized sentiment and emotion vocabularies for different topic categories, such as for technology products, the airline industry, restaurant and hotel services, and any other industry-specific customer products and/or services.

The techniques for contextual sentiment text analysis also overcome many of the accuracy problems that conventional statistical sentiment analysis models are subject to by reducing both false positives and false negatives that may occur from a low coverage sentiment vocabulary, and by compensating for negation. The techniques for contextual sentiment text analysis also overcome conventional models by reducing sentiment polarity or score differences between different topic categories and domains due to the lack of a contextualized sentiment vocabulary, such as for use of the term “predictable” in the movie review context versus the consumer electronics context for a reliable device.

In the techniques for contextual sentiment text analysis, the context of sentiments can be determined as pertaining to topic categories. For example, in a restaurant service review, the sentiment adjective “slow” would indicate a negative sentiment in the topic category of restaurant service, whereas in the context of a yoga class, the term “slow” would indicate a positive sentiment in the topic category of yoga instruction. The techniques described herein can be implemented to identify and distinguish the relevant situational context, such as for the topic categories of restaurant service and yoga instruction in the example. The sentiment analysis application is implemented to identify and, as-needed, dynamically load the relevant contextualized sentiment vocabulary based on what is determined as the most relevant context of the sentiments as pertaining to the topic categories. The sentiment analysis application can identify and load the context vocabulary for the positive and negative sentiment words (e.g., adjectives or adverbs), and for n-grams or multi-word terms (e.g., “low cost”, “high quality”, and the like).

While features and concepts of contextual sentiment text analysis can be implemented in any number of different devices, systems, networks, environments, and/or configurations, embodiments of contextual sentiment text analysis are described in the context of the following example devices, systems, and methods.

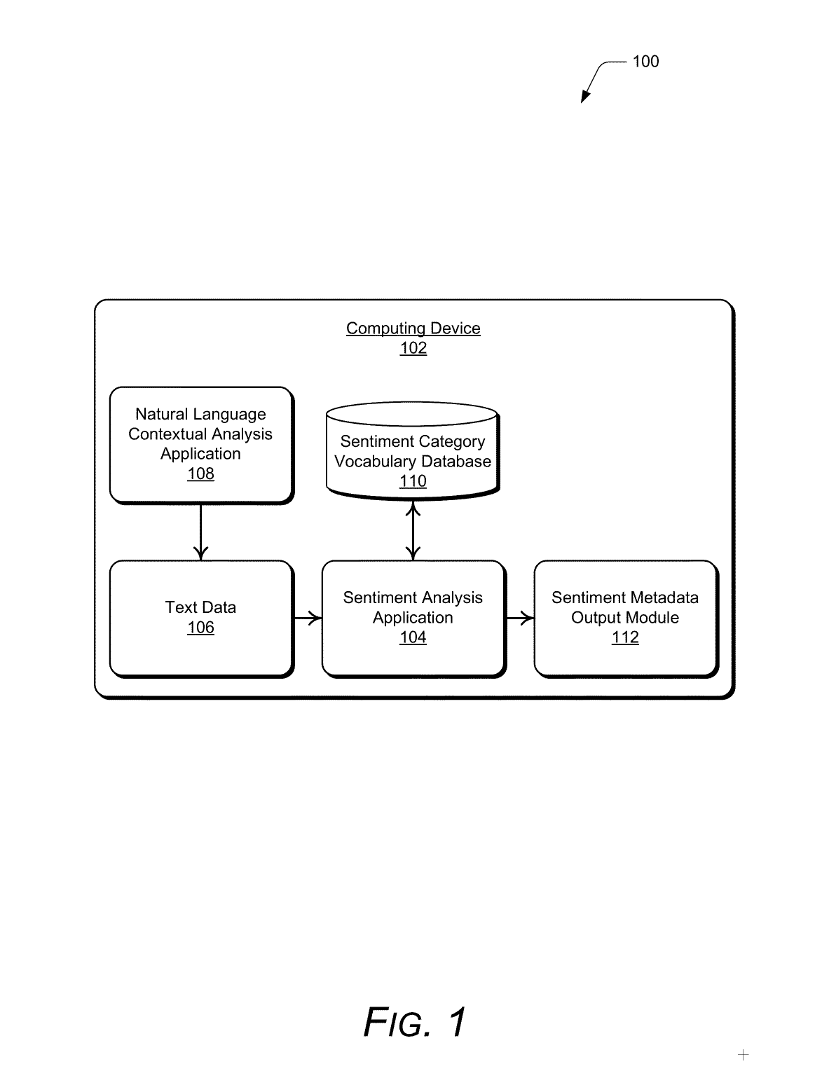

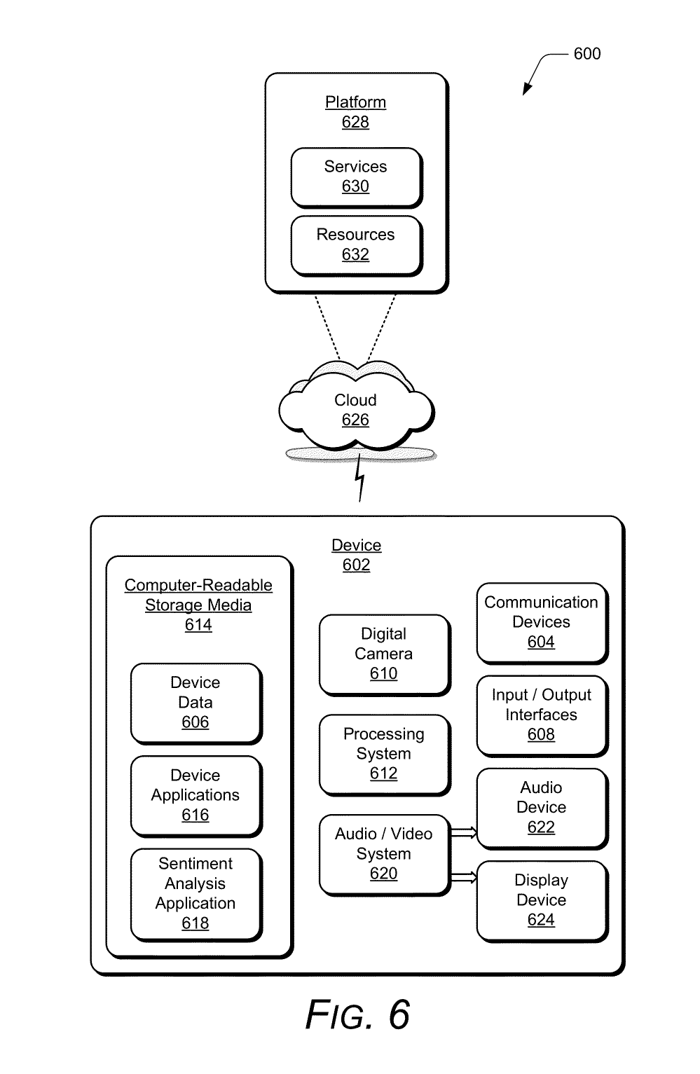

FIG. 1 illustrates an example 100 of a computing device 102 that implements a sentiment analysis application 104 in embodiments of contextual sentiment text analysis. The sentiment analysis application 104 can be implemented as a software application, such as executable software instructions (e.g., computer-executable instructions) that are executable by a processing system of the computing device 102 and stored on a computer-readable storage memory of the device. The computing device can be implemented with various components, such as a processing system and memory, and with any number and combination of differing components as further described with reference to the example device shown in FIG. 6.

In embodiments, the sentiment analysis application 104 implements techniques for contextual sentiment text analysis of text data 106 that is input to the sentiment analysis application. In this example, the computing device 102 also includes a natural language contextual analysis application 108 (e.g., a software application) that is implemented to generate the text data 106. Alternatively, the natural language contextual analysis application 108 may be implemented by another computing device (or server system) at which the text data 106 is generated and communicated to the computing device 102 as the input to the sentiment analysis application 104.

The text data 106 may be a sentence, multiple sentences, messages, documents, communications, and the like, and includes identified noun expressions, identified verb expressions, and tagged part-of-speech information, as determined by the natural language contextual analysis application 108. The natural language contextual analysis application 108 is a document, paragraph, and sentence segmenter, tokenizer, and a part-of-speech tagger that uses optimized lexical and contextual rules for grammar transformation. In implementations, the natural language contextual analysis application 108 generates a segmented and tokenized word punctuation list for each sentence of the text data.

Conventional part-of-speech tagging techniques can be inaccurate, particularly for capitalized words at the beginning of a sentence. For example, part-of-speech tagging of a customer comment such as “Poor quality!” or “Rich flavor!” will frequently result in the capitalized adjective being mis-tagged as a proper noun, and in the later sentiment analysis stages, the presence of important adjectives can be completely missed. This type of error can occur due to insufficient or inappropriate training data used by the underlying part-of-speech tagger. In implementations to improve part-of-speech tagging accuracy, the natural language contextual analysis application 108 can be implemented with a collection or ensemble of diverse part-of-speech taggers that are combined to increase the accuracy. The ensemble of part-of-speech taggers can arrive at a part-of-speech determination for any given word by using multiple part-of-speech taggers (e.g., three or more) to identify potential errors, or to select the more likely or correct tag based on agreement.

The collection or ensemble of diverse part-of-speech taggers that are combined in implementations of the natural language contextual analysis application 108 can be implemented as a preprocessing step in which part-of-speech tags for each word are obtained from the different, diverse part-of-speech taggers and then consolidated into a new term (part-of-speech vocabulary) by voting on part-of-speech tag agreement, which can then be reviewed by a human curation process. Alternatively or in addition, the collection of diverse part-of-speech taggers can be implemented as a run-time ensemble part-of-speech tagging system in which the part-of-speech tags from all of the diverse taggers are collected and then voted on to yield an answer. The human curation process is feasible when the vocabulary size is consolidated and can be flagged for output. The run-time ensemble can be used when the vocabulary size makes human review impractical. In both cases, use of the proper ensemble part-of-speech tagging method significantly increases the part-of-speech tag accuracy resulting in improved accuracy of sentiment analysis results in the subsequent processing stages.

In embodiments, the sentiment analysis application 104 can be implemented to determine a context of a sentiment as it pertains to a topic category of a subject determined from the text data 106. The sentiment analysis application can determine the topic category of the subject based on text categorization of the text data, such as by using one or an ensemble of text classifiers that accept either user-specified context categories, a window of the last n-number of sentences in the text data, or the current sentence. When either of the latter two inputs are used, a first text classifier uses a general hierarchical topic taxonomy pre-constructed from terms in the training corpus for each context category. A second text classifier uses an automatically constructed general hierarchical topic taxonomy provided by any number open-source resources, such as on-line resources (e.g., Wikipedia®) and/or other open-source resources. Other text classification methods may be used as well. Alternatively or in addition, the sentiment analysis application may explicitly indicate a particular context category. In implementation, the text classifiers return candidate context categories, and the top m-number of topic categories can be used to select the contextual sentiment vocabulary or n-gram lexicon from of a dictionary of terms and associated sentiment score.

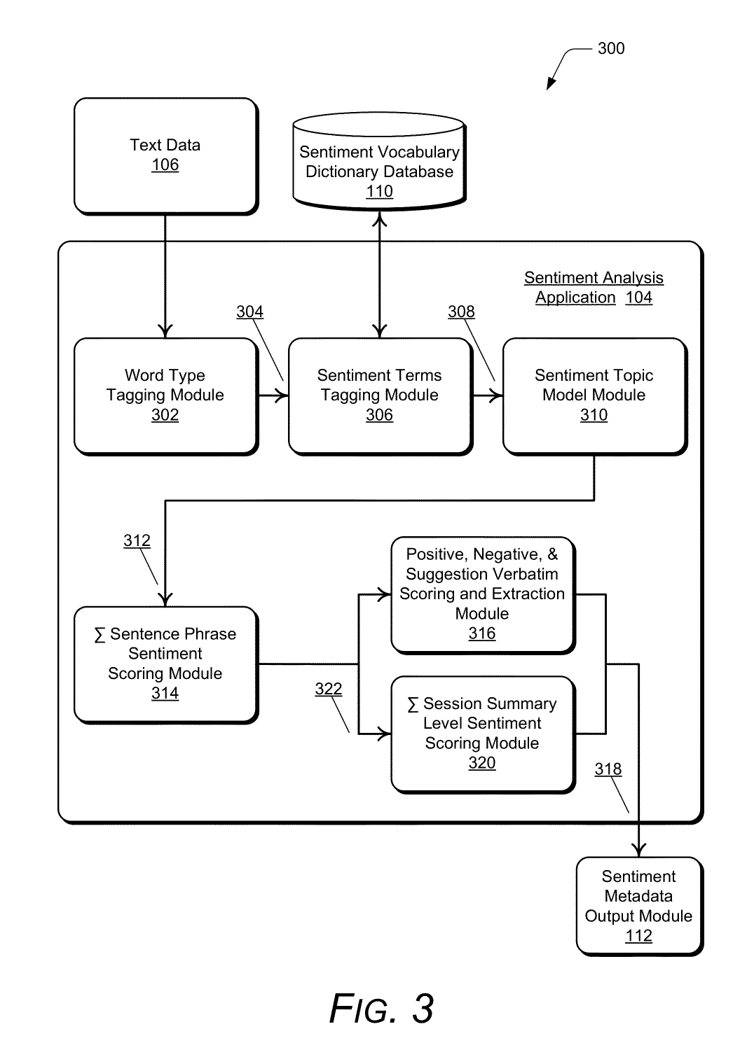

The computing device 102 can also include a sentiment category vocabulary database 110 that is implemented as an input to the sentiment analysis application 104. As with the natural language contextual analysis application 108, the sentiment category vocabulary database 110 may be implemented by another computing device (or server system) that communicates with the computing device 102 for use of the vocabulary database by modules of the sentiment analysis application 104. Modules and other features of the sentiment analysis application 104 are further described with reference to FIG. 3. The sentiment category vocabulary database 110 is a non-contextualized affect and sentiment vocabulary database containing pre-defined vocabulary and phrase elements. In implementations, the sentiment category vocabulary database is organized by category and developed by machine learning that processes hundreds of thousands of annotated or semi-annotated review examples across hundreds of topic categories, such as from on-line reviews, blogs, and the like. The sentiment category vocabulary database 110 includes contextual sentiment term vocabulary and term weights for each domain category, and topic model keywords are then used to select specific category weightings that are used by the modules of the sentiment analysis application 104.

The computing device 102 also includes a sentiment metadata output module 112 that is implemented to generate a formatted output from the sentiment analysis application 104. The sentiment metadata output module 112 collects affect and sentence expression level, part-of-speech level, and sentiment vocabulary terms and scores, and organizes this data into a format that can be programmatically accessed by one or more client applications. The output metadata can also be organized into a hierarchical structure.

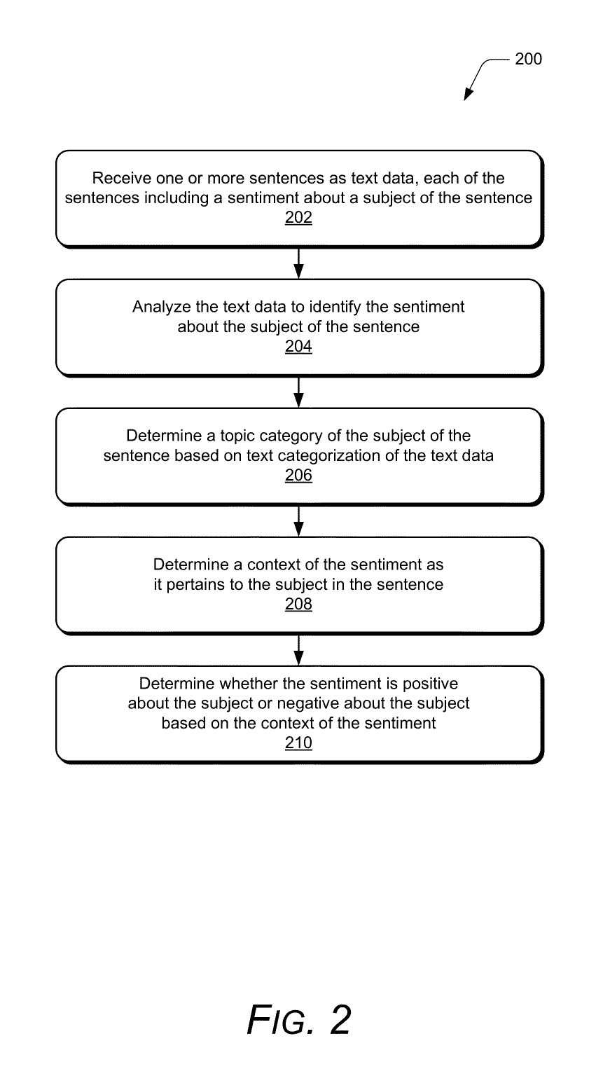

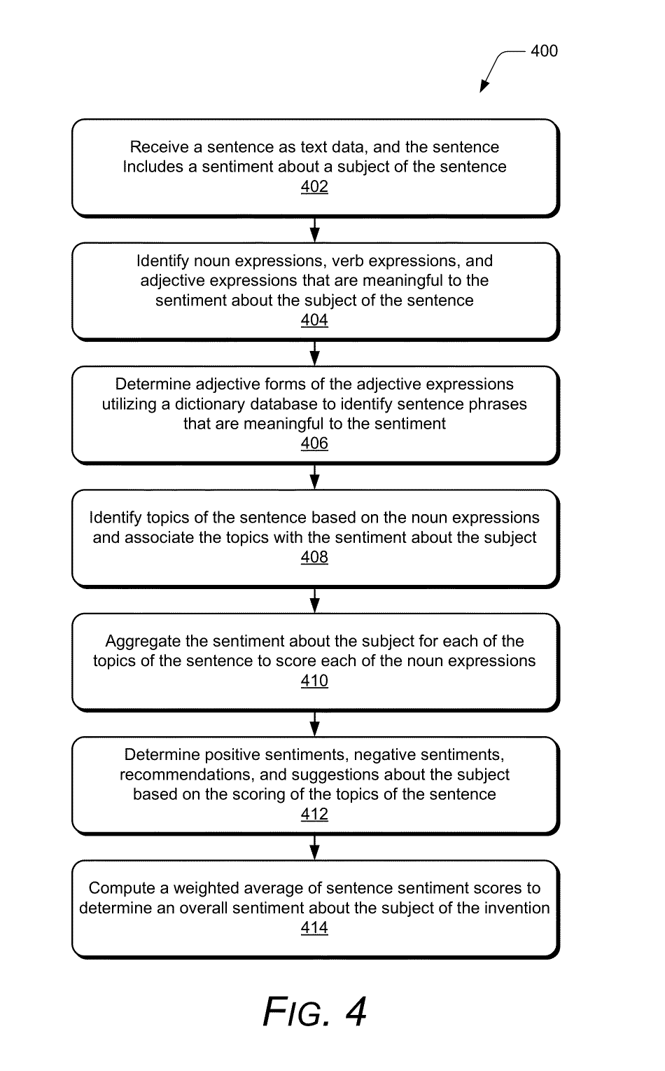

Example methods 200 and 400 are described with reference to respective FIGS. 2 and 4 in accordance with one or more embodiments of contextual sentiment text analysis. Generally, any of the services, components, modules, methods, and operations described herein can be implemented using software, firmware, hardware (e.g., fixed logic circuitry), manual processing, or any combination thereof. The example method may be described in the general context of executable instructions stored on a computer-readable storage memory that is local and/or remote to a computer processing system, and implementations can include software applications, programs, functions, and the like.

FIG. 2 illustrates example method(s) 200 of contextual sentiment text analysis, and is generally described with reference to a sentiment analysis application implemented by a computing device. The order in which the method is described is not intended to be construed as a limitation, and any number or combination of the method operations can be combined in any order to implement a method, or an alternate method.

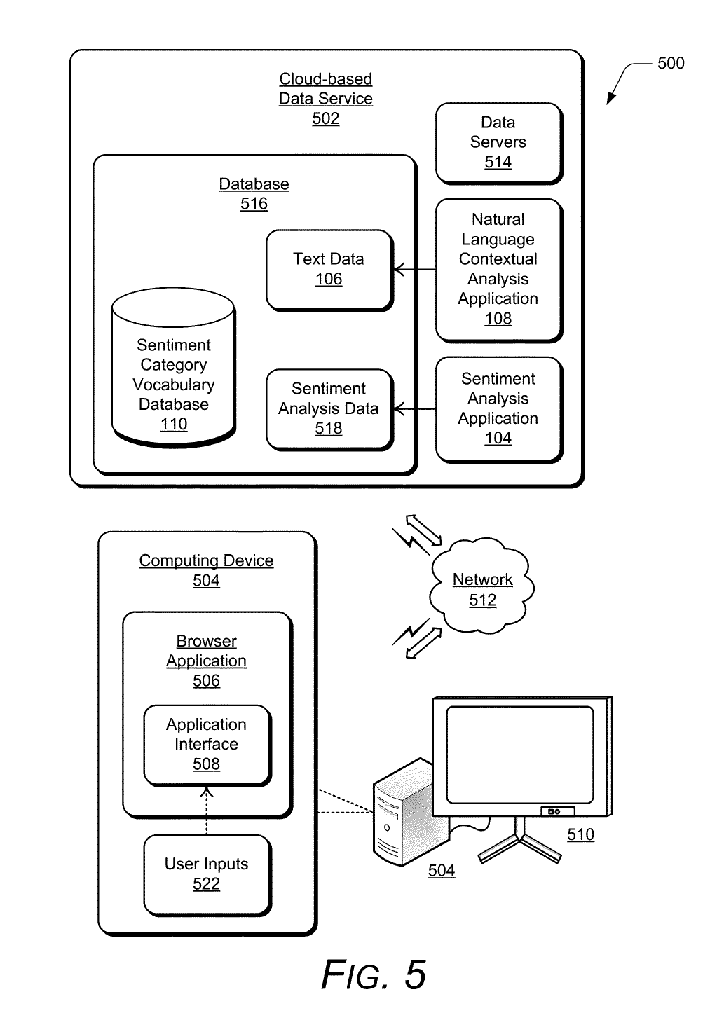

At 202, one or more sentences are received as text data, and each of the sentences can include a sentiment about a subject of the sentence. For example, the sentiment analysis application 104 (FIG. 1) that is implemented by the computing device 102 (or implemented at a cloud-based data service as described with reference to FIG. 5) receives one or more sentences as the text data 106, and each of the sentences can include a sentiment about a subject of the sentence. The text data is received as part-of-speech information that includes one or more of noun expressions, verb expressions, and tagged parts-of-speech of the sentences.

At 204, the text data is analyzed to identify the sentiment about the subject, and at 206, a topic category of the subject of the sentence is determined based on text categorization of the text data. For example, the sentiment analysis application 104 analyzes the text data 106 to identify a sentiment about the subject of a sentence, and determines a topic category of the subject of the sentence based on text categorization of the text data 106. In implementation, the sentiment analysis application 104 utilizes one or more text classifiers that accept user-specified context categories, a window of the last n-number of sentences in the text data, or the current sentence, and the text classifiers return topic categories from which the topic category of the subject of the sentence can be selected.

At 208, a context of the sentiment as it pertains to the topic category of the subject in the sentence is determined and, at 210, a determination is made as to whether the sentiment is positive about the subject or negative about the subject based on the context of the sentiment within the topic category of the subject. For example, the sentiment analysis application 104 determines a context of the sentiment as it pertains to the topic category of the subject in the sentence, and determines whether the sentiment (determined at 204) is positive about the subject or negative about the subject of the sentence based on the context of the sentiment and within the topic category of the subject.

FIG. 3 illustrates an example 300 of the sentiment analysis application 104 that is implemented by the computing device 102 as described with reference to FIG. 1, and that implements embodiments of contextual sentiment text analysis. The sentiment analysis application 104 includes various modules that implement features of the sentiment analysis application. Although shown and described as independent modules of the sentiment analysis application, any one or combination of the various modules may be implemented together or independently in the sentiment analysis application in embodiments of contextual sentiment text analysis.

The sentiment analysis application 104 includes a word type tagging module 302 that is implemented to receive the text data 106 as the part-of-speech information that includes noun expressions, verb expressions, and tagged parts-of-speech of one or more sentences. The text data 106 can include sentences that express positive, neutral, and negative sentiments, as well as suggestions and/or recommendations about a subject of a sentence. For example, the text data 106 may include customer comments, such as “I love this software application”, “I would recommend this application to others”, “Your software is too expensive”, and “Add some text edit features to the application”.

The word type tagging module 302 is implemented to identify and tag noun, verb, adjective and adverb sentence fragment expressions, as well as tag and group parts-of-speech of the sentences. The word type tagging module 302 provides a two-level sentence tagging structure for subsequent sentiment annotation. Words within each fragment or phrase are first tagged with their part-of-speech (e.g., as a noun, verb, adjective, adverb, determiner, etc.), and then lexical expression types for each grouping of the words and part-of-speech tags are assigned. The lexical expression types include noun expressions, verb expressions, and adjective expressions, and the word type tagging module 302 generates a two-level sentence expression and part-of-speech tag structure for each sentence, which is output at 304. The output structure identifies the elements of a sentence, such as where the noun expressions are most likely to occur in the sentence, and the adjective expressions that describe the elements in the sentence.

The sentiment analysis application 104 also includes a sentiment terms tagging module 306 that is implemented to determine adjective forms of the adjective expressions utilizing the sentiment vocabulary dictionary database 110 to identify meaningful sentence phrases. The sentiment analysis application 104 receives the part-of-speech annotated source words and computes the sentiment polarity, intensity, and context for each submitted adjective, adverb, and noun term. The sentiment terms tagging module 306 can utilize the sentiment category vocabulary database 110, such as a default non-contextualized sentiment vocabulary that is constant across categories, or a domain specific contextualized sentiment vocabulary for selected categories, given one or more category context words. The sentiment terms tagging module 306 can tag and annotate each sentiment word in the two-level tag structure, and generate an annotated data structure, which is output at 308.

The sentiment analysis application 104 also includes a sentiment topic model module 310 that receives the annotated data structure and is implemented to identify and extract the key topic noun expressions from each sentence. The sentiment topic model module 310 determines the topic categories of the subjects of sentences in the text data based on text categorization. In implementations, the sentiment topic model module 310 also accepts as input a sentiment neutral topic model, such as from the natural language contextual analysis application 108, and generates a weighted topic model indicating fine-grain sentiment for specific words and/or lexical terms, such as the noun expressions and adjective expressions. The sentiment topic model module 310 tags the noun terms of a sentence that is processed as the text data 106 as topics of the sentence based on the noun expressions, and associates each of the topics with the sentiment about the subject of the sentence. The determined topics of the input sentence text data are output as a noun expressions topic model from the sentiment topic model module at 312.

The sentiment analysis application 104 also includes a sentence phrase sentiment scoring module 314 that is implemented to aggregate the sentiment about the subject for each of the one or more topics of the sentence to score each of the noun expressions as represented by one of the topics of the sentence. The sentence phrase sentiment scoring module 314 computes the overall emotion and sentiment polarity and score for each topic model noun expression and sentence based on the earlier sentiment annotations and scores for each expression (or fragment) using individual word sentiment term scores and counts. The sentence and phrase-level sentiment scoring is performed to assign a positive or negative value score to each specific phrase within a sentence based on the presence of affect and sentiment keywords in that phrase. Phrase-level sentiment and affect scores are then summed to yield a sentence level score normalized by the total number of adjectives, adverbs, and nouns in the sentence. Sentences may have a zero score in the event that no sentiment or affect keywords are detected. The noun expression topic models are also retained at this stage for use by the sentiment metadata output module 112.

The sentiment analysis application 104 also includes a positive, negative, and suggestion verbatim scoring and extraction module 316 that is implemented to determine and extract the highest scoring positive and negative sentiment sentences, as well as actionable suggestion and/or recommendation sentences, and collect them into separate lists to indicate the most important positive, negative, and suggestion verbatims. The important (e.g., high scoring) positive, negative, and suggestion sentences are identified and extracted by the extraction module 316 by ranking the sentences based on score and by detection of actionable terms and keywords. The extraction module 316 can be implemented with heuristics that use natural language and statistics to determine the most important positive and negative verbatims, as well as the recommendations and/or suggestions. The separate lists of the most important positive, negative, and suggestion verbatims can then be accessed at the output 318 by the sentiment metadata output module 112.

The sentiment analysis application 104 also includes a session summary level sentiment scoring module 320 that is implemented to collect and count the positive and negative sentiment and affect contribution for all of the terms, and computes an aggregate affect and sentiment score. The sentence level sentiment score information and annotated terms from the sentence phrase sentiment scoring module 314 are input at 322 to the session summary level sentiment scoring module 320, which determines session or collection level sentiment scoring by computing a weighted average of all the sentence sentiment scores. The sentiment scoring module 320 can be implemented to provide a measure of the net sentiment expressed in a group of sentences that typically represent a conversation or collection of feedback comments. The sentence-level and session-level sentiment and affect annotations, sentiment score metadata, part-of-speech statistics, and optional verbatim statements are forwarded to the sentiment metadata output module 112 at the output 318.

The sentiment metadata output module 112 can then generate a formatted output from the sentiment analysis application 104. For example, the output module can organize the examples of the customer comments “I love this software application”, “I would recommend this application to others”, “Your software is too expensive”, and “Add some text edit features to the application” that are input as the text data 106. The generated output can indicate verbatim positive remarks, such as “I love this software application” and “I would recommend this application to others”. The generated output can also include verbatim negative remarks, such as “Your software is too expensive”, as well as verbatim suggestions or recommendations, such as “Add some text edit features to the application”.

FIG. 4 illustrates example method(s) 400 of contextual sentiment text analysis, and is generally described with reference to a sentiment analysis application implemented by a computing device. The order in which the method is described is not intended to be construed as a limitation, and any number or combination of the method operations can be combined in any order to implement a method, or an alternate method.

At 402, a sentence is received as text data, and the sentence includes a sentiment about a subject of the sentence. For example, the word type tagging module 302 (FIG. 3) of the sentiment analysis application 104 receives a sentence as the text data 106, and the sentence includes a sentiment about a subject of the sentence. The text data is received as part-of-speech information that includes one or more of noun expressions, verb expressions, and tagged parts-of-speech of the sentence.

At 404, noun expressions, verb expressions, and adjective expressions that are meaningful to the sentiment about the subject are identified. For example, the word type tagging module 302 of the sentiment analysis application 104 identifies the noun expressions, the verb expressions, and the adjective expressions that are meaningful to the sentiment about the subject of the sentence from the part-of-speech information in the text data 106.

At 406, adjective forms of the adjective expressions are determined utilizing a dictionary database to identify sentence phrases that are meaningful to the sentiment about the subject. For example, the sentiment terms tagging module 306 of the sentiment analysis application 104 determines one or more adjective forms of the adjective expressions utilizing the vocabulary database 110 of categorized sentiment vocabulary words to identify sentence phrases that are meaningful to the sentiment about the subject of the sentence.

At 408, topics of the sentence are identified based on the noun expressions and the topics are associated with the sentiment about the subject. For example, the sentiment topic model module 310 of the sentiment analysis application 104 identifies topics of the sentence based on the noun expressions, and the topics are associated with the sentiment about the subject of the sentence.

At 410, the sentiment about the subject is aggregated for each of the topics of the sentence to score each of the noun expressions. For example, the sentence phrase sentiment scoring module 314 of the sentiment analysis application 104 aggregates the sentiment about the subject for each of the topics of the sentence to score each of the noun expressions as represented by one of the topics of the sentence.

At 412, positive sentiments, negative sentiments, recommendations, and suggestions about the subject are determined based on the scoring of the topics of the sentence. For example, the positive, negative, and suggestion verbatim scoring and extraction module 316 of the sentiment analysis application 104 determines positive sentiments about the subject, negative sentiments about the subject, recommendations about the subject, and/or suggestions about the subject based on the scoring of the topics of the sentence.

At 414, a weighted average of sentence sentiment scores is computed to determine an overall sentiment about the subject of the sentence. For example, the session summary level sentiment scoring module 320 of the sentiment analysis application 104 computes a weighted average of sentence sentiment scores to determine an overall sentiment about the subject of the sentence.

FIG. 5 illustrates an example system 500 in which embodiments of contextual sentiment text analysis can be implemented. The example system 500 includes a cloud-based data service 502 that a user can access via a computing device 504, such as any type of computer, mobile phone, tablet device, and/or other type of computing device. The computing device 504 can be implemented with a browser application 506 through which a user can access the data service 502 and initiate a display of an application interface 508, such as a user interface of the sentiment analysis application 104, which may be displayed on a display device 510 that is connected to the computing device. The computing device 504 can be implemented with various components, such as a processing system and memory, and with any number and combination of differing components as further described with reference to the example device shown in FIG. 6.

In embodiments of contextual sentiment text analysis, the cloud-based data service 502 is an example of a network service that provides an on-line, Web-based version of the sentiment analysis application 104 that a user can log into from the computing device 504 and display the application interface 508. The network service may be utilized by any client, such as marketers and product and/or service providers, to generate analysis outputs and reports to determine topics that customers are discussing or communicating, as well as the related sentiments, emotions, and opinions that are being expressed by customers in their communications. The data service can also maintain and/or upload the text data 106 that is input to the sentiment analysis application 104.

Any of the devices, data servers, and networked services described herein can communicate via a network 512, which can be implemented to include a wired and/or a wireless network. The network can also be implemented using any type of network topology and/or communication protocol, and can be represented or otherwise implemented as a combination of two or more networks, to include IP-based networks and/or the Internet. The network may also include mobile operator networks that are managed by a mobile network operator and/or other network operators, such as a communication service provider, mobile phone provider, and/or Internet service provider.

The cloud-based data service 502 includes data servers 514 that may be implemented as any suitable memory, memory device, or electronic data storage for network-based data storage, and the data servers communicate data to computing devices via the network 512. The data servers 514 maintain a database 516 of the text data 106, as well as the various types of sentiment analysis data 518 that is generated by the sentiment analysis application 104. The cloud-based data service 502 can also include the natural language contextual analysis application 108 that generates the text data 106, and the database 516 may include the sentiment category vocabulary database 110 that is utilized by the sentiment analysis application 104 to generate the sentiment analysis data.

The cloud-based data service 502 includes the sentiment analysis application 104, such as a software application (e.g., executable instructions) that is executable with a processing system to implement embodiments of contextual sentiment text analysis. The sentiment analysis application 104 can be stored on a computer-readable storage memory, such as any suitable memory, storage device, or electronic data storage implemented by the data servers 514. Further, the data service 502 can include any server devices and applications, and can be implemented with various components, such as a processing system and memory, as well as with any number and combination of differing components as further described with reference to the example device shown in FIG. 5.

The data service 502 communicates the sentiment analysis data and the application interface 508 of the sentiment analysis application 104 to the computing device 504 where the application interface is displayed, such as through the browser application 506 and displayed on the display device 510 of the computing device. The sentiment analysis application 104 can also receive user inputs 518 to the application interface 508, such as when a user at the computing device 504 initiates a user input with a computer input device or as a touch input on a touchscreen of the device. The computing device 504 communicates the user inputs 520 to the data service 502 via the network 512, where the sentiment analysis application 104 receives the user inputs.

FIG. 6 illustrates an example system 600 that includes an example device 602, which can implement embodiments of contextual sentiment text analysis. The example device 602 can be implemented as any of the devices and/or server devices described with reference to the previous FIGS. 1-5, such as any type of client device, mobile phone, tablet, computing, communication, entertainment, gaming, media playback, digital camera, and/or other type of device. For example, the computing device 102 shown in FIG. 1, as well as the computing device 504 and the data service 502 (and any devices and data servers of the data service) shown in FIG. 5 may be implemented as the example device 602.

The device 602 includes communication devices 604 that enable wired and/or wireless communication of device data 606, such as user images and other associated image data. The device data can include any type of audio, video, and/or image data, as well as the images and denoised images. The communication devices 604 can also include transceivers for cellular phone communication and/or for network data communication.

The device 602 also includes input/output (I/O) interfaces 608, such as data network interfaces that provide connection and/or communication links between the device, data networks, and other devices. The I/O interfaces can be used to couple the device to any type of components, peripherals, and/or accessory devices, such as a digital camera device 610 and/or display device that may be integrated with the device 602. The I/O interfaces also include data input ports via which any type of data, media content, and/or inputs can be received, such as user inputs to the device, as well as any type of audio, video, and/or image data received from any content and/or data source.

The device 602 includes a processing system 612 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 602 may further include any type of a system bus or other data and command transfer system that couples the various components within the device. A system bus can include any one or combination of different bus structures and architectures, as well as control and data lines.

The device 602 also includes computer-readable storage media 614, such as storage memory and data storage devices that can be accessed by a computing device, and that provide persistent storage of data and executable instructions (e.g., software applications, programs, functions, and the like). Examples of computer-readable storage media include volatile memory and non-volatile memory, fixed and removable media devices, and any suitable memory device or electronic data storage that maintains data for computing device access. The computer-readable storage media can include various implementations of random access memory (RAM), read-only memory (ROM), flash memory, and other types of storage media in various memory device configurations.

The computer-readable storage media 614 provides storage of the device data 606 and various device applications 616, such as an operating system that is maintained as a software application with the computer-readable storage media and executed by the processing system 612. In this example, the device applications also include a sentiment analysis application 618 that implements embodiments of contextual sentiment text analysis, such as when the example device 602 is implemented as the computing device 102 shown in FIG. 1 or the data service 502 shown in FIG. 5. An example of the sentiment analysis application 618 includes the sentiment analysis application 104 implemented by the computing device 102 and/or at the data service 502, as described in the previous FIGS. 1-5.

The device 602 also includes an audio and/or video system 620 that generates audio data for an audio device 622 and/or generates display data for a display device 624. The audio device and/or the display device include any devices that process, display, and/or otherwise render audio, video, display, and/or image data, such as the image content of a digital photo. In implementations, the audio device and/or the display device are integrated components of the example device 602. Alternatively, the audio device and/or the display device are external, peripheral components to the example device.

In embodiments, at least part of the techniques described for contextual sentiment text analysis may be implemented in a distributed system, such as over a “cloud” 626 in a platform 628. The cloud 626 includes and/or is representative of the platform 628 for services 630 and/or resources 632. For example, the services 630 may include the data service 502 as described with reference to FIG. 5. Additionally, the resources 632 may include the sentiment analysis application 104, the natural language contextual analysis application 108, and/or the sentiment category vocabulary database 110 that are implemented at the data service as described with reference to FIG. 5.

The platform 628 abstracts underlying functionality of hardware, such as server devices (e.g., included in the services 630) and/or software resources (e.g., included as the resources 632), and connects the example device 602 with other devices, servers, etc. The resources 632 may also include applications and/or data that can be utilized while computer processing is executed on servers that are remote from the example device 602. Additionally, the services 630 and/or the resources 632 may facilitate subscriber network services, such as over the Internet, a cellular network, or Wi-Fi network. The platform 628 may also serve to abstract and scale resources to service a demand for the resources 632 that are implemented via the platform, such as in an interconnected device embodiment with functionality distributed throughout the system 600. For example, the functionality may be implemented in part at the example device 602 as well as via the platform 628 that abstracts the functionality of the cloud 626.

Although embodiments of contextual sentiment text analysis have been described in language specific to features and/or methods, the appended claims are not necessarily limited to the specific features or methods described. Rather, the specific features and methods are disclosed as example implementations of contextual sentiment text analysis.

1. A method, comprising:
receiving a sentence as text data that includes a sentiment about a subject of the sentence;
analyzing the text data to identify the sentiment about the subject;
determining a topic category of the subject of the sentence based on text categorization of the text data;
determining a context of the sentiment as the sentiment pertains to the topic category of the subject in the sentence; and
determining whether the sentiment is positive about the subject or negative about the subject based on the context of the sentiment within the topic category of the subject.

2. The method as recited in claim 1, wherein the text data is said received as part-of-speech information that includes one or more of noun expressions, verb expressions, and tagged parts-of-speech of the sentence.

3. The method as recited in claim 2, further comprising:
identifying the noun expressions, the verb expressions, and adjective expressions that are meaningful to the sentiment about the subject, said identifying the noun expressions, the verb expressions, and the adjective expressions from the part-of-speech information.

4. The method as recited in claim 3, further comprising:
determining one or more adjective forms of the adjective expressions utilizing a dictionary database of categorized sentiment vocabulary words to identify sentence phrases that are meaningful to the sentiment about the subject.

5. The method as recited in claim 3, further comprising:
identifying one or more topics of the sentence based on the noun expressions; and
associating each of the one or more topics with the sentiment about the subject.

6. The method as recited in claim 5, further comprising:
aggregating the sentiment about the subject for each of the one or more topics of the sentence to score each of the noun expressions as represented by one of the topics of the sentence.

7. The method as recited in claim 6, further comprising:
determining one or more of positive sentiments about the subject, negative sentiments about the subject, recommendations about the subject, and suggestions about the subject based on the scoring of the topics of the sentence; and
computing a weighted average of sentence sentiment scores to determine an overall sentiment about the subject of the sentence.

8. A computing device, comprising:
a memory configured to maintain text data that is received as one or more sentences;
a processor system to implement a sentiment analysis application that is configured to:
analyze the text data to identify sentiments that are expressed about subjects of the one or more sentences;
determine a context of each of the sentiments as they pertain to topic categories of the subjects in the one or more sentences, the topic categories of the subjects being determinable based on text categorization of the text data; and
determine whether each of the sentiments is positive about a subject or negative about the subject based on the context of each sentiment within the topic category of the subject.

9. The computing device as recited in claim 8, wherein the text data is maintained as part-of-speech information that includes one or more of noun expressions, verb expressions, and tagged parts-of-speech of the sentence.

10. The computing device as recited in claim 9, wherein the sentiment analysis application is configured to identify, based on the part-of-speech information, the noun expressions, the verb expressions, and adjective expressions that are meaningful to each of the sentiments about the subjects.

11. The computing device as recited in claim 10, wherein the sentiment analysis application is configured to determine one or more adjective forms of the adjective expressions utilizing a dictionary database of categorized sentiment vocabulary words to identify sentence phrases that are meaningful to each of the sentiments about the subjects.

12. The computing device as recited in claim 10, wherein the sentiment analysis application is configured to:
identify one or more topics of the one or more sentences based on the noun expressions; and
associate each of the one or more topics with the sentiments about the subjects.

13. The computing device as recited in claim 12, wherein the sentiment analysis application is configured to aggregate the sentiments about the subjects for each of the one or more topics of the one or more sentences to score each of the noun expressions as represented by one of the topics of the sentence.

14. The computing device as recited in claim 13, wherein the sentiment analysis application is configured to:
determine one or more of positive sentiments about the subjects, negative sentiments about the subjects, recommendations about the subjects, and suggestions about the subjects based on the scoring of the topics of the one or more sentences; and
compute a weighted average of sentence sentiment scores to determine an overall sentiment about the subjects of the one or more sentences.

15. A computer-readable storage memory comprising a sentiment analysis application stored as instructions that are executable and, responsive to execution of the instructions by a computing device, the computing device performs operations of the sentiment analysis application comprising to:
receive sentences as text data, each of the sentences including a sentiment about a subject of the sentence, the text data for a sentence including one or more of noun expressions, verb expressions, and tagged parts-of-speech of the sentence;
analyze the text data to identify the sentiment about the subject;
determine a context of the sentiment as the sentiment pertains to a topic category of the subject in the sentence, the topic category of the subject determined based on text categorization of the text data; and
determine whether the sentiment is positive about the subject or negative about the subject based on the context of the sentiment within the topic category of the subject.

16. The computer-readable storage memory as recited in claim 15, wherein the computing device performs operations of the sentiment analysis application further comprising to identify the noun expressions, the verb expressions, and adjective expressions that are meaningful to the sentiment about the subject, said identifying the noun expressions, the verb expressions, and the adjective expressions from the part-of-speech information.

17. The computer-readable storage memory as recited in claim 16, wherein the computing device performs operations of the sentiment analysis application further comprising to determine one or more adjective forms of the adjective expressions utilizing a dictionary database of categorized sentiment vocabulary words to identify sentence phrases that are meaningful to the sentiment about the subject.

18. The computer-readable storage memory as recited in claim 16, wherein the computing device performs operations of the sentiment analysis application further comprising to:
identify one or more topics of the sentence based on the noun expressions; and
associate each of the one or more topics with the sentiment about the subject.

19. The computer-readable storage memory as recited in claim 18, wherein the computing device performs operations of the sentiment analysis application further comprising to aggregate the sentiment about the subject for each of the one or more topics of the sentence to score each of the noun expressions as represented by one of the topics of the sentence.

20. The computer-readable storage memory as recited in claim 19, wherein the computing device performs operations of the sentiment analysis application further comprising to:
determine one or more of positive sentiments about the subject, negative sentiments about the subject, recommendations about the subject, and suggestions about the subject based on the scoring of the topics of the sentence; and
compute a weighted average of sentence sentiment scores to determine an overall sentiment about the subject of the sentence.
